(19) United States
(12) Patent Application Publication
(10) Pub. No.: US 2013/0314676 A1
(43) Pub. Date: Nov. 28, 2013

(54) PROJECTION MODULE

(71) Applicants: SING WU, Hukou Township (TW); Tze-Yun Sung, Hukou Township (TW)

(72) Inventors: SING WU, Hukou Township (TW); Tze-Yun Sung, Hukou Township (TW)

(21) Appl. No.: 13/481,867

(22) Filed: May 28, 2012

(51) Int. Cl. G03B 21/14

(52) U.S. Cl. 353/85

(57) ABSTRACT

The present invention is related to an improved projection module, and more particularly, to a projection module integrated with necessary combinations so as to reduce error probabilities of circuit designs. In accordance with the present invention, an improved projection module includes a panel, a panel driving circuit and a light driving circuit. Accordingly, in accordance with the novel combination of the present invention, a projector manufacturer can be easy to use its own conditions to develop suitable products. Therefore, the burdens and error probabilities of designing circuits in development can be reduced.

### BACKGROUND OF THE DISCLOSURE

a) Field of the Disclosure

The invention relates to an improved projection module, and more particularly, to a projection module integrated with necessary combinations so as to reduce error probabilities of circuit designs.

b) Brief Description of the Related Art

A supplier of traditional miniaturized projection modules provides a panel containing a projection optical system for a projector manufacturer to use it. However, the panel is not provided with driving circuits such that standard electronic image signals cannot be converted into signals suitable for the panel. Therefore, some circuits are necessary to be integrated, but this integration is complicated and has high error probabilities. This is led that the projector manufacturer has increased burdens.

With regards to the above miniaturized projector, beside the integration of the panel and the optical system, a light source and driving circuits thereof also play key roles. However, a driving circuit for the light source has a complicated design, and thus errors often happen. In accordance with the market demand, the present invention provides a novel combination so as to pursue product competition effectiveness.

### SUMMARY OF THE DISCLOSURE

The present invention has an improved projection module integrated with a panel and driving circuits for a panel and a light source.

In accordance with the present invention, an improved projection module includes a panel, a panel driving circuit and a light driving circuit, wherein electronic signals coming from the panel driving circuit is required by the panel for projecting images, wherein the panel driving circuit converts standard image electronic signals into the electronic signals suitable for the panel.

In accordance with the present invention, an improved projection module includes a panel, a panel driving circuit and a light driving circuit, wherein a light coming from a light energy converted from an electric energy by the light driving circuit is required by the panel for projecting images such that a light source can be formed for light illumination.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a block diagram of a projection module in accordance with the present invention.

FIG. 2 is a schematic view of operation of a projection module in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

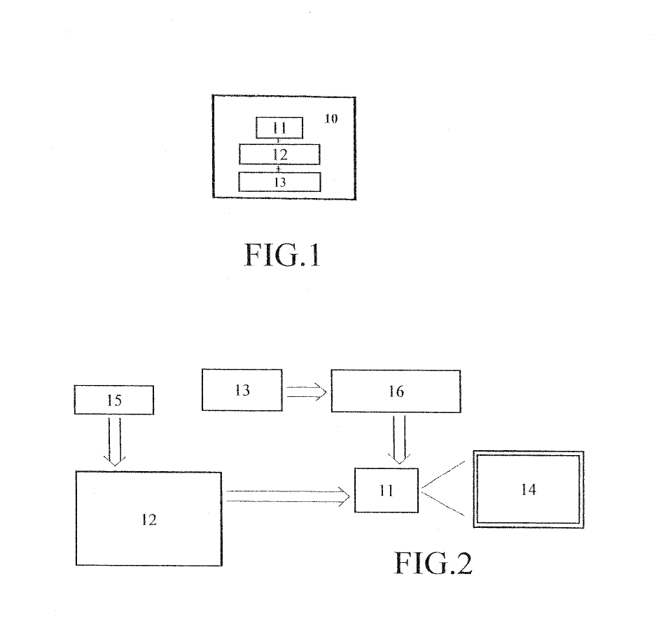

FIG. 1 is a block diagram of a projection module in accordance with the present invention. Referring to FIG. 1, in accordance with the present invention, a projection module 10 mainly includes a panel 11, a panel driving circuit 12 and a light driving circuit 13.

FIG. 2 is a schematic view of operation of a projection module in accordance with the present invention. Referring to FIG. 2, electronic signals coming from the panel driving circuit 12 is required by the panel 11 for projecting images 14, wherein the panel driving circuit 12 converts standard image electronic signals 15 into the electronic signals suitable for the panel 11.

Referring to FIG. 2, a light coming from a light energy converted from an electric energy by the light driving circuit 13 is required by the panel 11 for projecting images 14 such that a light source 16 can be formed for light illumination.

Accordingly, in accordance with the novel combination of the present invention, a projector manufacturer can be easy to use its own conditions to develop suitable products. Therefore, the burdens and error probabilities of designing circuits in development can be reduced.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values.

Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An improved projection module comprises a panel, a panel driving circuit and a light driving circuit, wherein electronic signals coming from the panel driving circuit is required by the panel for projecting images, wherein the panel driving circuit converts standard image electronic signals into the electronic signals suitable for the panel, wherein a light coming from a light energy converted from an electric energy by the light driving circuit is required by the panel for projecting images such that a light source can be formed for light illumination.
